(19) United States
(12) Patent Application Publication
(10) Pub. No.: US 2018/0131539 A1
(43) Pub. Date: May 10, 2018

(54) Communication System for Aggregates and Controllers of a Vehicle, and Vehicle Comprising the Communication System

(71) Applicant: Bayerische Motoren Werke Aktiengesellschaft, Muenchen (DE)

(72) Inventors: Hans-Ulrich MICHEL, Mallersdorf (DE); Dirk KAULE, Muenchen (DE); Hauke STAEHLE, Muenchen (DE); Christian BUCKL, Wangen (DE)

(21) Appl. No.: 15/865,852

(22) Filed: Jan. 9, 2018

Related U.S. Application Data
(63) Continuation of application No. PCT/EP2016/057891, filed on Apr. 11, 2016.

(30) Foreign Application Priority Data
Jul. 10, 2015 (DE) 10 2015 212 951.9

(51) Int. Cl. H04L 12/40; B60R 16/023; H04L 12/707

(52) U.S. Cl. CPC H04L 12/40176; H04L 2012/40273; H04L 45/24; B60R 16/0231

(57) ABSTRACT

A communication system for units and controllers of a vehicle includes a unit configured to transmit a plurality of messages to a controller. A first communication path is configured to transfer a message from the plurality of messages between the unit and the controller, and a second communication path configured to transfer the message from the plurality of messages between the unit and the controller. The second communication path is redundant with respect to the first communication path, and the unit is configured to transmit the plurality of messages to the controller alternately via the first communication path or the second communication path.

### CROSS REFERENCE TO RELATED APPLICATIONS

This application is a continuation of PCT International Application No. PCT/EP2016/057891, filed Apr. 11, 2016, which claims priority under 35 U.S.C. § 119 from German Patent Application No. 10 2015 212 951.9, filed Jul. 10, 2015, the entire disclosures of which are herein expressly incorporated by reference.

### BACKGROUND AND SUMMARY OF THE INVENTION

The invention relates to a communication system for units and/or controllers of a vehicle and/or to a vehicle comprising the communication system for units and controllers. In particular, the invention relates to a communication system for the efficient use of the data rate of communication paths given simultaneous fault tolerance for safety-relevant units and/or controllers of a vehicle.

Traditional communication systems in vehicles, particularly motor vehicles, typically have no redundancy for the communication. For this reason, traditional communication systems in vehicles are for the most part not fault tolerant toward failure of a communication channel. For safety-critical systems in vehicles, it is possible for redundant communication channels to be used on which messages are sent redundantly. Examples of redundant communication channels with redundant transfer of the messages can be found in the Time-Triggered Protocol TTP, the Avionics Full Duplex Switched Ethernet ADFX or the field bus system FlexRay. However, the redundant transfer of the messages by the redundant communication channels does not lead to an increase in the available data rate. Instead, the available data rate of the redundant communication channels is used for the redundant transfer of the messages.

It is therefore an object of the invention to improve a communication system of a vehicle. In particular, it is an object of the invention to increase the usable data rate of the communication system of a vehicle and at the same time to make certain of fault tolerance.

This object is achieved by the features of the independent patent claims. Advantageous refinements and developments of the invention emerge from the dependent claims.

The invention is distinguished by a communication system for units and controllers of a vehicle. By way of example, the communication system may be configured such that the communication system allows messages to be sent only between units and/or only between controllers and/or arbitrary combinations of units and controllers. The communication system comprises a unit that is configured to transmit a multiplicity of messages to a controller, a first communication path that is configured to transfer a message from the multiplicity of messages between the unit and the controller, and a second communication path that is configured to transfer a message from the multiplicity of messages between the unit and the controller. The second communication path is redundant in regard to the first communication path. The unit may further be configured to transmit the multiplicity of messages to the controller alternately via the first communication path or the second communication path. The alternate transmission of the messages via the first and the second, redundant, communication path allows the communication system to be efficiently protected against failure of a communication path. The controller can receive messages via at least one communication path. Redundant transmission of the messages via both communication paths is not necessary. The data rate of the two communication paths can be used cumulatively for the transfer of an increased number of messages between the unit and the controller.

According to one advantageous refinement, the controller may be configured to receive the multiplicity of messages of the unit alternately via the first communication path or the second communication path. By way of example, the first communication path and the second communication path can alternate in each time step. Advantageously, the controller is connected redundantly, so that alternate reception of the messages is easily possible.

According to a further advantageous refinement, the first communication path and the second communication path can alternate consistently for each message from the multiplicity of messages. This allows a symmetrical or consistent alternation of the communication channel to be defined. By way of example, the first communication path and the second communication path can be used alternately to transmit messages of the unit to the controller. A first message can be sent via the first communication path, for example. A second message can be sent via the second communication path. A third message can in turn be sent via the first communication path. The alternate use of the communication paths for each message allows the messages to be easily split onto the communication paths. If a communication channel fails, at least half of the messages can continue to be received by the controller.

According to a further advantageous refinement, the first communication path and the second communication path can alternate inconsistently or asymmetrically for each message from the multiplicity of messages. Asymmetrically means that the messages are sent in irregularly distributed fashion via the first or the second communication path. The choice of communication path can be made on the basis of the maximum available data rate of the first and the second communication path, for example. An asymmetric distribution of the messages can have the advantage that when the data rate of the communication paths is distributed inconsistently, the cumulative data rate of the communication paths can be used efficiently for the transfer of the messages. If a communication path fails, it is possible to make certain of an appropriate transfer of the messages to the controller and hence the function of the controller even when the messages are distributed asymmetrically.

According to a further advantageous refinement, the first communication path and the second communication path can guarantee a predefined transfer quality for each message from the multiplicity of messages between the unit and the controller. This allows guaranteed delivery of the messages to be defined. By way of example, a maximum delay for a message can be stipulated.

According to a further advantageous refinement, a message from the multiplicity of messages can include all the data from the unit that are needed by the controller for carrying out a function. The sending of all the data for carrying out a function on the controller in a message allows each message to be carried out on the controller independently of another message. Preferably, a loss of a message has no effect on the processing of another message.

According to a further advantageous refinement, a function of the controller can be determined on the basis of a frequency of the received messages from the multiplicity of messages of the unit. This allows the function of the controller to be easily adapted to suit the frequency of the received messages.

According to a further advantageous refinement, the controller can adapt the function on the basis of the frequency of the received messages of the unit. Advantageously, the function of the controller can be adapted dynamically to suit the frequency of the received messages.

According to a further advantageous refinement, a message from the multiplicity of messages may be an Ethernet frame. Advantageously, the communication system can easily be applied to Ethernet.

The invention moreover relates to a vehicle comprising a communication system for units and controllers, wherein the communication system is configured as described above.

Further features of the invention emerge from the claims, the figures and the description of the figures. All the features and combinations of features that are cited in the description above and the features and combinations of features that are cited in the description of the figures below and/or that are shown in the figures can be used not only in the respectively indicated combination but also in other combinations or else on their own.

The invention is based on the considerations set out below:

Vehicles for highly autonomous driving require communication systems for safety-relevant components that are fault tolerant. This means that even in the event of a fault a vehicle should continue to be able to travel autonomously, i.e. without driver intervention. Shutdown of a safety-relevant component, e.g. of a controller, a sensor, an actuator and/or a unit, in the event of a fault can lead to critical traffic situations in which the vehicle continues to travel autonomously without being able to resort to information of a safety-relevant component, or the driver is surprisingly compelled by the shutdown of a safety-relevant component to take over control of the vehicle.

For components in vehicles, it is possible for different safety levels to be defined. By way of example, ISO standard 26262 defines different safety levels, what are known as Automotive Safety Integrity Levels ASIL. Safety-relevant components in vehicles need to comply with the highest safety level ASIL-D in this case. By way of example, ASIL-D requires a particular level of failsafety from components at the hardware level. This can be achieved by redundant design of the components, particularly the communication paths.

Redundant communication paths allow the available data rate to be increased and at the same time additional fault tolerance to be guaranteed. In detail, redundant communication paths between all the safety-relevant or safety-critical components allow the data rate to be increased. In order to obtain fault tolerance, the transmitter of a message can send the message alternately via at least two different, redundant communication paths to the receiver. The alternate sending of the message via at least two different, redundant communication paths does not give rise to additional messages. The message can be protected by means of an integrity check, e.g. a cyclic redundancy check. The alternate sending via at least two different redundant communication paths allows the messages of one communication path the messages to be received by a receiver despite failure or defect in any communication element, e.g. a link, a switch, a cable, a line and/or a plug connector. If 50% of the messages of the transmitter are sent via each of the two redundant communication paths, then the receiver can still receive 50% of the messages despite failure or defect in one communication path. The receiver can supply messages to and/or execute the associated application at a reduced frequency, e.g. a halved frequency. Diminishment of function or degradation of function can occur in the application of the receiver. The function of the application, albeit at diminished frequency, is assured, however. If the application is a control application, then control can continue to take place. The control application does not have to be shut down.

Advantageously, no unnecessary static redundancy is needed for the transfer of the messages between the transmitter and the receiver. The increase in the redundant communication paths increases the usable data rate. At the same time, a fault tolerance for the failure behavior Fail-Operational is achieved. Fail-Operational means that the communication system continues to operate in the event of a fault. The communication system does not assume a fault situation by virtue of individual components of the communication system having to be shut down, for example. The communication system continues to remain operative. The communication system can therefore be referred to as fault tolerant.

Other objects, advantages and novel features of the present invention will become apparent from the following detailed description of one or more preferred embodiments when considered in conjunction with the accompanying drawings.

### BRIEF DESCRIPTION OF THE DRAWINGS

A preferred exemplary embodiment of the invention is described below with reference to the appended drawings. This results in further details, preferred refinements and developments of the invention.

FIG. 1 schematically shows one embodiment of a communication system.

### DETAILED DESCRIPTION OF THE DRAWINGS

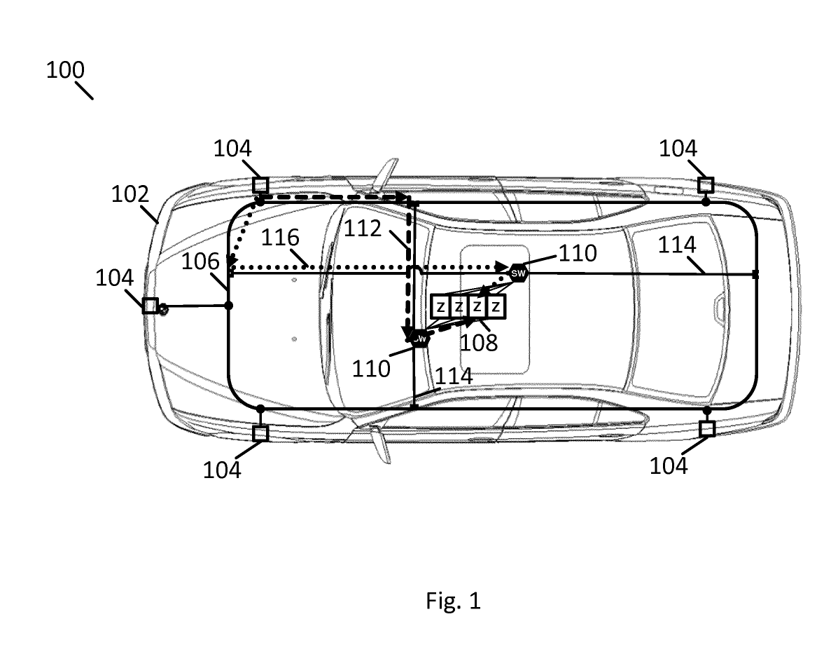

In detail, FIG. 1 shows a communication system 100 of a vehicle 102 in a first and a second time step. The vehicle 102 may be a motor vehicle. By way of example, the vehicle 102 may be an automobile or a motorcycle. The communication system 100 can comprise a multiplicity of units 104. A unit 104 may be a sensor and/or an actuator, for example. Preferably, a unit 104 is a safety-relevant or safety-critical unit. A unit 104 may be connected to a communication network 106. The unit 104 may be connected to the communication network 106 redundantly. The unit 104 may be connected to the communication network 106 via a switch 110. The unit 104 may be connected to the communication network 106 via a spur line. Preferably, the communication network 106 is a packet-switched network, e.g. Ethernet. The communication network 106 may be a segment of a communication network. The communication network 106 can comprise further network segments 114. The network segments 114 may be connected to the communication network 106 via spur lines and/or switches.

The communication network 106 can comprise a controller 108. Preferably, the communication network 106 can comprise multiple controllers 108. The controllers 108 may be arranged in the same or in a different network segment, e.g. network segment 114, of the communication network 106. A controller 108 may be connected to the communication network 106 and/or 114 via a switch 108. Preferably, a controller 108 is connected to the communication network 106 redundantly via at least two switches 110. Preferably, a switch 110 is an Ethernet switch. A switch 110 may be connected to the network 106 via a further switch and/or via a spur line. One or more controllers 108 may be connected to a switch 110.

A message can be exchanged between a unit 104 and a controller 108 via one or more switches 110. A message can also be exchanged directly between the unit 104 and the controller 108. A message may be an Ethernet frame. A unit 104 can send or transmit a message to a controller 108 in a time step. The unit 104 can send the message to the controller via a predefined or static communication path. Preferably, the unit 104 can send the message via one of at least two predefined, redundant communication paths. A communication path can be defined by a static switching table of one or more switches 110. The use of a static switching table between unit 104 and a controller 108 allows a predefined transmission quality to be stipulated for each message. By way of example, the unit 104 can send a first message to the controller via a first predefined communication path 112 in a first time step and can send a second message to the controller 108 via a second predefined communication path 116 in a second time step. Preferably, the first and second communication paths are redundant. The use of a first communication path 112 and a second, redundant communication path 116 makes it possible to make certain that a unit 104 can continue to communicate with a controller 108 in the event of failure in a communication path.

The unit 104 can use each of the at least two redundant communication paths 112 and 116 to transfer a message to a controller. Preferably, a message is transferred only by one of the at least two redundant communication paths 112 and 116. In exceptional situations, e.g. given particularly safety-critical messages or messages with very high prioritization, it is also possible for messages to use the at least two redundant communication paths 112 and 116 for simultaneous transfer. Which communication path the unit 104 uses for the transfer can be stipulated by the unit 104 itself. Alternatively, an external component can compute which communication path the unit 104 can use for the transfer of a message. Preferably, it is possible to configure whether the unit itself or an external component stipulates which communication path is used for the transfer of a message. The unit 104 can transfer messages alternately, i.e. in symmetrically or consistently alternating fashion, on the first communication path 112 and the second communication path 116, for example. The unit 104 can transfer the messages in asymmetrically or inconsistently alternating fashion on the first communication path 112 and the second communication path 116, for example. By way of example, the unit 104 can alternate the first and second communication paths on the basis of the maximum data rate and/or the available data rate of the first and/or the second communication channel. If the first communication path has e.g. a maximum data rate of 100 Mbit/s and the second communication path has e.g. a maximum data rate of 50 Mbit/s, the unit 104 can send two thirds of the messages via the first communication path and one third of the messages via the second communication path. In this example, the unit 104 can use the data rate of both communication paths, a total of 150 Mbit/s. Therefore, the data rate, particularly the data rates of different communication paths, can be used efficiently.

Each controller 108 can receive the message or the messages of the unit 104 or of the units 104. Preferably, each controller 108 is connected to a unit 104 via at least two predefined, redundant communication paths. Each controller 108 can receive the message or the messages via a first communication path, e.g. communication path 112, and a second, redundant communication path, e.g. communication path 116. The message or the messages can be received from a unit 104 directly or via one or more switches and/or network segments. Each message that is received by a controller 108 can be processed and/or executed by the controller 108, particularly by an application of the controller 108. The processing and/or execution of each received message allows a function of the controller to be stipulated. The frequency at which the controller 108 receives the message or the messages of the unit 104 can influence the scope or the frequency with which the function of the controller is executed.

If a fault or failure in a communication path, e.g. in the first communication path 112, occurs, then the controller can only receive the messages via a redundant communication path, e.g. the second communication path 116. Since a message or each message of a unit can comprise all the data that the controller needs in order to be able to process or execute the message and/or in order to provide the function of the controller, the controller can process and/or execute a message independently of another message. The frequency at which the controller receives the messages via the redundant communication path can determine the frequency at which the function of the controller is executed. In the event of a fault, particularly in the event of failure in a communication path, a reduced frequency of messages can arise that can lead to a reduced frequency of the function of the controller. However, even when the frequency of function execution is diminished, the function of the controller is assured. Shutting down the controller and/or (sub)functions of the controller may therefore not be necessary. In particular, shutting down (sub)functions of the controller that are dependent on discontinued or un-transferred messages may therefore not be necessary.

If the unit increases the frequency of the messages via the redundant communication path in the event of a fault, for example, then the controller can receive the messages of the unit and execute the function of the controller at the same frequency. A fault or failure in a communication path cannot impair the function of the controller in this case. In the event of a fault, the function of the controller can therefore continue to be used. Shutting down the controller is not necessary. Further, the data rate of the redundant communication channel between unit and controller can be used to transfer more messages. Redundant transfer of the messages is therefore not necessary. The function of the controller can admittedly be limited or diminished. However, the function of the controller continues to be operatively usable.

The use of Ethernet frames further makes it possible to make certain that the available data rate is used better. In contrast to methods that use fixed time slots, for example, it is possible for Ethernet frames to be transferred at any time. It is not necessary to wait for a free and/or the next time slot. The transfer can therefore be implemented more efficiently.

A vehicle that travels highly autonomously and is reliant on the function of the controller can continue to use the function of the controller in the event of a fault or a failure in a communication path. The vehicle can also continue to travel highly autonomously with reduced function. The driver does not have to surprisingly take action in the control of the vehicle in the event of a fault. The autonomous travel time of the vehicle can therefore be extended. Further, it is possible to make certain that the safety-relevant or safety-critical units and/or controllers function in the event of failure or malfunction in a communication path. A fault that can lead to failure in a communication path in this case may be a defective plug connector, a defective cable and/or a defective network component such as a switch, for example. Therefore, a single fault that leads to a failure in a communication channel can be handled efficiently in the communication system. The communication system is fault tolerant in the event of failure in a communication path.

### LIST OF REFERENCE SYMBOLS

100 Communication system
102 Vehicle
104 Unit
106 Segment of a communication system
108 Controller
110 Switch
112 Communication path
114 Segment of a communication system
116 Communication path

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A communication system for units and controllers of a vehicle, the communication system comprising:
a unit configured to transmit a plurality of messages to a controller;
a first communication path configured to transfer a message from the plurality of messages between the unit and the controller; and
a second communication path configured to transfer the message from the plurality of messages between the unit and the controller,
wherein the second communication path is redundant with respect to the first communication path, and
wherein the unit is configured to transmit the plurality of messages to the controller alternately via the first communication path or the second communication path.

2. The communication system as claimed in claim 1, wherein the controller is configured to receive the plurality of messages of the unit alternately via the first communication path or the second communication path.

3. The communication system as claimed in claim 1, wherein the first communication path and the second communication path alternate consistently for each of the plurality of messages.

4. The communication system as claimed in claim 2, wherein the first communication path and the second communication path alternate consistently for each of the plurality of messages.

5. The communication system as claimed in claim 1, wherein the first communication path and the second communication path alternate inconsistently for each of the plurality of messages.

6. The communication system as claimed in claim 2, wherein the first communication path and the second communication path alternate inconsistently for each of the plurality of messages.

7. The communication system as claimed in claim 1, wherein the first communication path and the second communication path guarantee a predefined transfer quality for each of the plurality of messages between the unit and the controller.

8. The communication system as claimed in claim 2, wherein the first communication path and the second communication path guarantee a predefined transfer quality for each of the plurality of messages between the unit and the controller.

9. The communication system as claimed in claim 1, wherein the message from the plurality of messages includes all the data from the unit that is needed by the controller for carrying out a function.

10. The communication system as claimed in claim 2, wherein the message from the plurality of messages includes all the data from the unit that is needed by the controller for carrying out a function.

11. The communication system as claimed in claim 3, wherein the message from the plurality of messages includes all the data from the unit that is needed by the controller for carrying out a function.

12. The communication system as claimed in claim 5, wherein the message from the plurality of messages includes all the data from the unit that is needed by the controller for carrying out a function.

13. The communication system as claimed in claim 7, wherein the message from the plurality of messages includes all the data from the unit that is needed by the controller for carrying out a function.

14. The communication system as claimed in claim 1, wherein a function of the controller is determined on the basis of a frequency of received messages from the plurality of messages of the unit.

15. The communication system as claimed in claim 2, wherein a function of the controller is determined on the basis of a frequency of received messages from the plurality of messages of the unit.

16. The communication system as claimed in claim 7, wherein a function of the controller is determined on the basis of a frequency of received messages from the plurality of messages of the unit.

17. The communication system as claimed in claim 9, wherein the function of the controller is determined on the basis of a frequency of received messages from the plurality of messages of the unit.

18. The communication system as claimed in claim 14, wherein the controller adapts the function on the basis of the frequency of the received messages of the unit.

19. The communication system as claimed in claim 1, wherein the message from the plurality of messages is an Ethernet frame.

20. A vehicle comprising a communication system for units and controllers, wherein the communication system comprises:
a unit configured to transmit a plurality of messages to a controller;
a first communication path configured to transfer a message from the plurality of messages between the unit and the controller; and
a second communication path configured to transfer the message from the plurality of messages between the unit and the controller,
wherein the second communication path is redundant with respect to the first communication path, and
wherein the unit is configured to transmit the plurality of messages to the controller alternately via the first communication path or the second communication path.
